(19) United States
(12) Patent Application Publication
(10) Pub. No.: US 2026/0103289 A1
(43) Pub. Date: Apr. 16, 2026

(54) AIRCRAFT INCLUDING AT LEAST ONE WING ATTACHMENT SYSTEM ENSURING OPTIMUM TRANSMISSION OF THRUST FORCES

(71) Applicant: Airbus Operations SAS, TOULOUSE (FR)

(72) Inventors: Kotaro FUKASAKU, TOULOUSE (FR); Rémi AMARGIER, TOULOUSE (FR); Alain RAZAFINDRABE, TOULOUSE (FR)

(21) Appl. No.: 19/355,115

(22) Filed: Oct. 10, 2025

(30) Foreign Application Priority Data
Oct. 16, 2024 (FR) FR2411204

(51) Int. Cl. B64D 27/40; B64D 27/12

(52) U.S. Cl. CPC B64D 27/402; B64D 27/12

(57) ABSTRACT

An aircraft with wings, an engine assembly, a primary structure of a pylon connecting the engine assembly and the wings and a wing attachment system connecting the primary structure and the wings and including first and second front wing attachments each configured to transmit forces in a longitudinal direction parallel to the thrust forces generated by the engine assembly, an intermediate wing attachment configured to transmit forces in the longitudinal direction and in a transverse and horizontal direction, and a rear wing attachment configured to transmit forces in a vertical direction and in the transverse and horizontal direction.

### CROSS-REFERENCES TO RELATED APPLICATIONS

This application claims the benefit of French Patent Application Number FR2411204 filed on Oct. 16, 2024, the entire disclosure of which is incorporated herein by way of reference.

### FIELD OF THE INVENTION

The present invention relates to an aircraft including at least one wing attachment system ensuring optimum transmission of thrust forces.

### BACKGROUND OF THE INVENTION

In one embodiment that can be seen in FIGS. 1 and 2 an aircraft 10 includes a plurality of propulsion assemblies 12 positioned under the wings 14 of the aircraft. Each propulsion assembly 12 includes an engine 16, a nacelle (not represented in FIG. 2) positioned around the engine 16, and a pylon 18 connecting the engine 16 and the wings 14. The pylon 18 includes a primary structure 20 that is connected to the engine 16 by an engine attachment system 22 and to the wings 14 by a wing attachment system 24.

In the present invention a longitudinal direction (denoted X in FIG. 3) is substantially (+/−10%) parallel to the rotation axis A16 of the engine. A longitudinal plane is a vertical plane parallel to the longitudinal direction. A transverse plane is a plane perpendicular to the rotation axis A16 of the engine. A horizontal transverse direction (denoted Y in FIG. 3) is a horizontal direction perpendicular to the rotation axis A16 of the engine. A vertical direction is denoted Z in FIG. 3. The terms front and rear refer to the direction of flow of the flow of air in the engine 16, which flows from front to rear.

The prior art engine attachment system 22 includes a front engine attachment 26, a rear engine attachment 28 and a pair of thrust links 30 absorbing thrust forces.

In a prior art embodiment that can be seen in FIG. 3 the wing attachment system 24 includes first and second front wing attachments 32.1, 32.2, an intermediate wing attachment 34 and a rear wing attachment 36. As depicted in FIG. 3 the first and second front wing attachments 32.1, 32.2 are configured to absorb forces oriented approximately in the vertical direction Z. The intermediate wing attachment 34 is configured to absorb forces oriented in the longitudinal direction and in the transverse and horizontal direction Y. The rear wing attachment 36 is configured to absorb forces oriented in the vertical direction Z and the transverse and horizontal direction Y.

In one configuration the first and second front wing attachments 32.1, 32.2 and the intermediate wing attachment 34 are connected to a first spar of the wings 14. The rear wing attachment 36 is connected to a second spar of the wings 14 offset toward the rear in the longitudinal direction X relative to the first spar.

In an embodiment that can be seen in FIG. 3 each of the first and second front wing attachments 32.1, 32.2 includes a two-point link 38, a first connecting rod 40.1 connecting the two-point link 38 and the first spar of the wings 14, and a second connecting rod 40.2 connecting the two-point link 38 and the primary structure 20. The first and second connecting rods 40.1, 40.2 are substantially parallel to one another and to the longitudinal and horizontal direction Y.

The intermediate wing attachment 34 is offset toward the rear in the longitudinal direction X relative to the first and second front wing attachments 32.1, 32.2. This intermediate wing attachment 34 is of the spigot type and includes a substantially cylindrical tenon 42.1 rigidly attached to the first spar of the wings 14 that has an axis A42.1 substantially parallel to the vertical direction Z and a housing 42.2 at the level of the primary structure 20 configured to accommodate without clearance the tenon 42.1 and which has an axis A42.2 substantially parallel to the vertical direction Z.

The rear wing attachment 36 includes at least one transverse and approximately triangular three-point link 44, first and second connecting rods 46.1, 46.2 connecting the primary structure 20 and the three-point link 44, and a third connecting rod 46.3 connecting the second spar of the wings 14 and the three-point link 44. The first, second and third connecting rods 46.1, 46.2, 46.3 are substantially parallel to one another and positioned in longitudinal and vertical planes XZ.

This embodiment is not entirely satisfactory because, most of the thrust forces generated by the engine 16 being transmitted to the wings 14 only via the intermediate wing attachment 34, the tenon 42.1 has a relatively large diameter, which leads to a relatively large overall size in the transverse and horizontal direction Y.

### SUMMARY OF THE INVENTION:

The present invention aims to remedy some or all of the drawbacks of the prior art.

To this end, the invention provides an aircraft having the features of one or more embodiments described herein.

In contrast to the prior art the thrust forces generated by the engine assembly are not transmitted exclusively via the intermediate wing attachment but divided between the first and second front wing attachments and the intermediate wing attachment, which contributes to optimizing the transmission of said thrust forces.

In accordance with another feature of the invention each of the first and second front wing attachments includes at least one two-point link, a first connecting rod connecting the two-point link and the primary structure, and a second connecting rod connecting the two-point link and the wings, the first and second connecting rods being parallel to one another and to the vertical direction, the second connecting rod being offset toward the rear in the longitudinal direction relative to the first connecting rod.

In accordance with another feature of the invention for each of the first and second front wing attachments the primary structure includes at least one first lug that includes an orifice to accommodate the first connecting rod, the wings including at least one second lug that includes an orifice to accommodate the second connecting rod. Additionally each of the first and second front wing attachments includes two two-point links substantially parallel to one another and spaced from one another between which the first and second lugs are positioned.

In accordance with another feature of the invention each of the first and second front wing attachments includes a cylindrical tenon rigidly attached to a first element of the combination comprising the primary structure and the wings which has an axis substantially parallel to the vertical direction and an oblong housing configured to accommodate the tenon and rigidly attached to a second element different from the first element of the combination comprising the primary structure and the wings that has a first dimension in the longitudinal direction equal to the diameter of the tenon and a second dimension in the transverse and horizontal direction greater than the diameter of the tenon. In accordance with another feature of the invention each tenon is rigidly attached to the primary structure, the oblong housing being rigidly attached to the wings.

In accordance with another feature of the invention the intermediate wing attachment includes at least one first three-point link, first and second connecting rods connecting the first three-point link and a first element of the combination comprising the primary structure and the wings, and a third connecting rod connecting the first three-point link and a second element different from the first element of the combination comprising the primary structure and the wings, the first, second and third connecting rods being parallel to one another and to the vertical direction.

In accordance with another feature of the invention the first and second connecting rods connect the first three-point link and the primary structure, the third connecting rod connecting the first three-point link and the wings.

In accordance with another feature of the invention the intermediate wing attachment includes a yoke rigidly attached to a first element of the combination comprising the primary structure and the wings, a lug cooperating with the yoke rigidly attached to a second element different from the first element of the combination comprising the primary structure and the wings, and a connecting rod parallel to the vertical direction connecting the yoke and the lug.

In accordance with another feature of the invention the rear wing attachment includes at least one second three-point link, first and second connecting rods connecting the second three-point link and a first element of the combination comprising the primary rod and the wings, and a third connecting rod connecting the second three-point link and a second element different from the first element of the combination comprising the primary structure and the wings, the first, second and third connecting rods being parallel to one another and to the longitudinal direction.

In accordance with another feature of the invention the first and second connecting rods connect the second three-point link and the primary structure, the third connecting rod connecting the second three-point link and the wings.

In accordance with another feature of the invention the rear wing attachment includes a yoke rigidly attached to a first element of the combination comprising the primary structure and the wings, a lug cooperating with the yoke rigidly attached to a second element different from the first of the combination comprising the primary structure and the wings, and a connecting rod parallel to the longitudinal direction connecting the yoke and the lug.

In accordance with another feature of the invention the wings include first and second spars, the second spar being offset toward the rear in the longitudinal direction relative to the first spar. Additionally the primary structure includes first and second transverse reinforcements, the second transverse reinforcement being offset toward the rear in the longitudinal direction relative to the first transverse reinforcement, the first and second front wing attachments and the intermediate wing attachment connecting the first spar and the first transverse reinforcement, the rear wing attachment connecting the second spar and the second transverse reinforcement.

In accordance with another feature of the invention the first and second front wing attachments and the intermediate wing attachment are positioned in substantially the same transverse plane.

In accordance with another feature of the invention at least one wing attachment from one of the first and second front wing attachments, the intermediate wing attachment and the rear wing attachment includes at least one connecting element consisting of a lug, a yoke, a two-point link or a three-point link that comprises at least two plates pressed one against the other.

### BRIEF DESCRIPTION OF THE DRAWINGS

Other features and advantages of the invention will emerge from the following description of the invention given by way of example only with reference to the appended drawings, in which:

FIG. 1 is a lateral view of an aircraft,

FIG. 2 is a lateral view of a propulsion assembly, its nacelle not being represented,

FIG. 3 is a perspective view of a primary structure of a pylon and a wing attachment system that depicts one prior art embodiment,

FIG. 4 is a schematic lateral representation of a propulsion assembly depicting one embodiment of the invention,

FIG. 5 is a schematic perspective view of a wing attachment system depicting one embodiment of the invention,

FIG. 6 is a front view of the rear wing attachment of the wing attachment system that can be seen in FIG. 5,

FIG. 7 is a view in section taken along the line VII-VII of the rear wing attachment that can be seen in FIG. 6,

FIG. 8 is a view from above of a front wing attachment of the wing attachment system that can be seen in FIG. 5,

FIG. 9 is a view in section taken along the line IX-IX of the front wing attachment that can be seen in FIG. 8,

FIG. 10 is a view from above of an intermediate wing attachment of the wing attachment system that can be seen in FIG. 5,

FIG. 11 is a view in section taken along the line XI-XI of the intermediate wing attachment that can be seen in FIG. 10,

FIG. 12 is a schematic perspective view of a wing attachment system depicting another embodiment of the invention,

FIG. 13 is a front view of the rear wing attachment of the wing attachment system that can be seen in FIG. 12,

FIG. 14 is a view from above of the intermediate wing attachment of the wing attachment system that can be seen in FIG. 12,

FIG. 15 is a view in longitudinal section of the front wing attachment of the wing attachment system that can be seen in FIG. 12, and

FIG. 16 is a view from above of the front wing attachment that can be seen in FIG. 15.

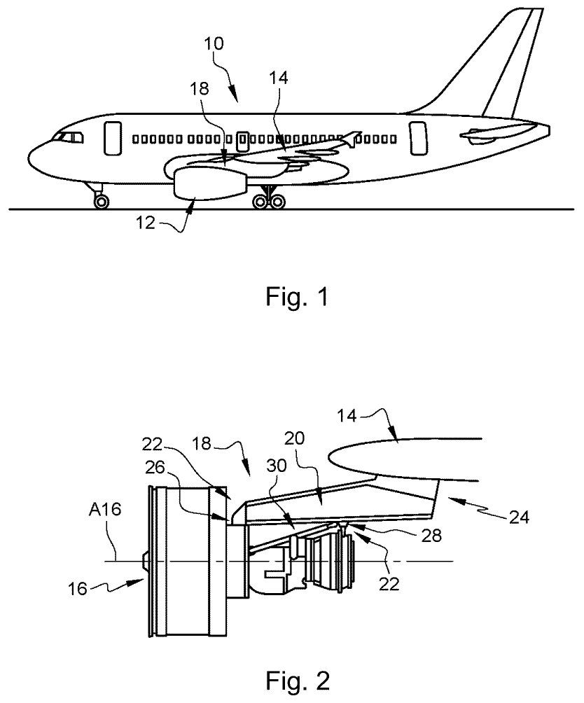

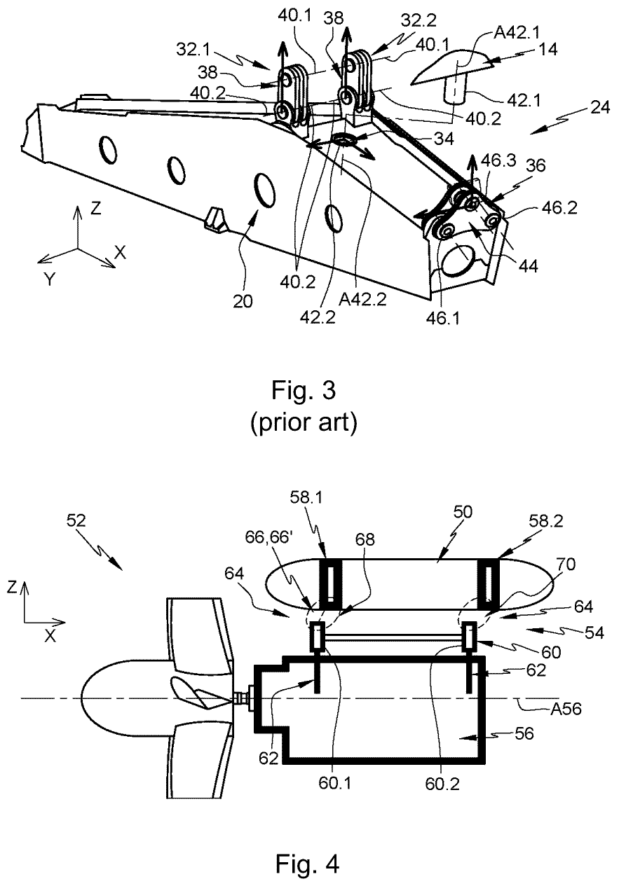

### DETAILED DESCRIPTION OF THE PREFERRED EMBODIMENTS

In an embodiment that can be seen in FIG. 4 an aircraft includes wings 50 and at least one propulsion assembly 52 positioned under the wings 50 and connected to the latter by pylons 54.

The propulsion assembly 52 includes an engine assembly 56 that has an engine assembly axis A56 parallel to a longitudinal direction X. This engine assembly 56 can be a jet engine or a turboprop engine. Regardless of the embodiment the engine assembly 56 generates thrust forces oriented in the longitudinal direction X.

The wings 50 include first and second spars 58.1, 58.2, the second spar 58.2 being offset toward the rear in the longitudinal direction X relative to the first spar 58.1.

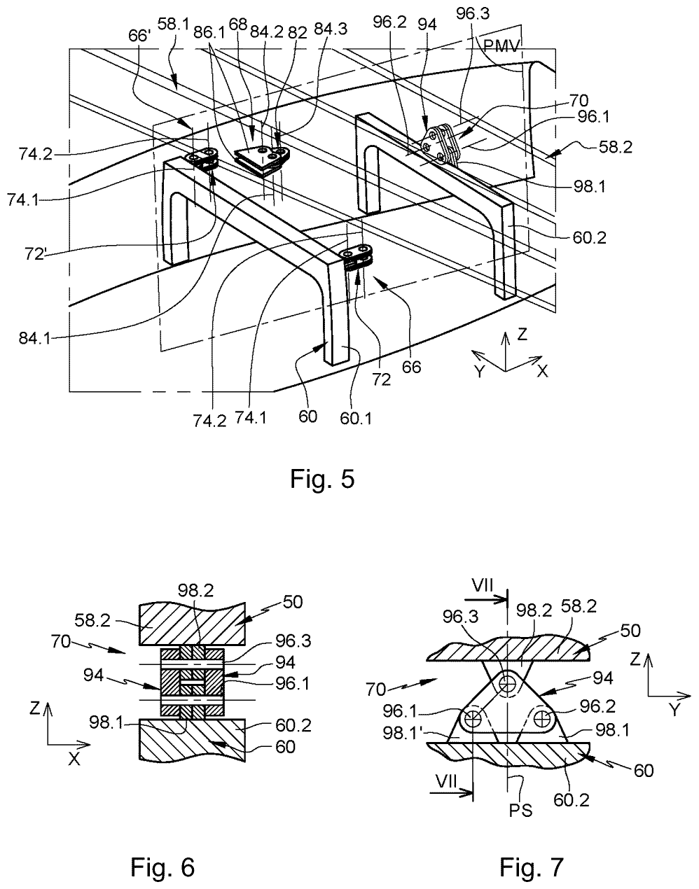

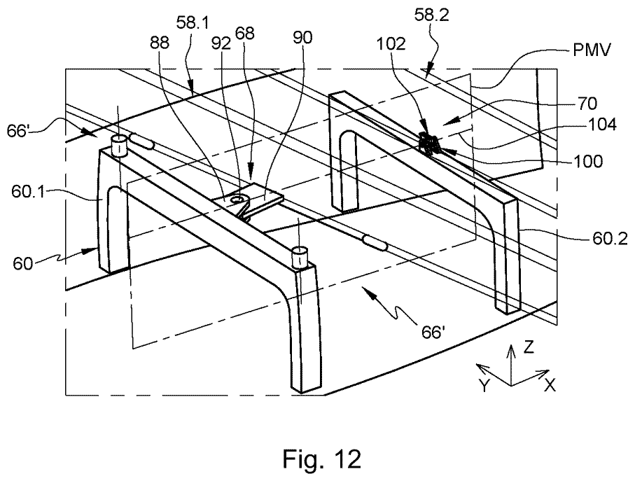

The pylon 54 includes a primary structure 60. The latter can be a cradle structure as depicted in FIGS. 5 and 12 or a box structure, depending in particular on the nature of the engine assembly 56. The primary structure 60 includes first and second transverse reinforcements 60.1, 60.2, the second transverse reinforcement 60.2 being offset toward the rear in the longitudinal direction X relative to the first transverse reinforcement 60.1.

The propulsion assembly 52 includes at least one engine attachment system 62 connecting the primary structure 60 and the engine assembly 56 and at least one wing attachment system 64 connecting the primary structure 60 and the wings 50.

The wings 50, the engine assembly 56, the primary structure 60 and the engine attachment system 62 are not further described because they can be identical to those of the prior art.

The wing attachment system 64 has a median vertical plane PMV. In one configuration this median vertical plane PMV contains the engine assembly axis A56.

The wing attachment system 64 includes first and second front wing attachments 66, 66′ positioned on respective opposite sides of the median vertical plane PMV, an intermediate wing attachment 68 and a rear wing attachment 70. The intermediate and rear wing attachments 68, 70 are in the median vertical plane PMV. In one arrangement the median vertical plane PMV is a plane of symmetry for the first and second front wing attachments 66, 66′.

In a preferred configuration the first and second front wing attachments 66, 66′ and the intermediate wing attachment 68 connect the first transverse reinforcement 60.1 of the primary structure 60 and the first spar 58.1 of the wings 50. Complementing this the rear wing attachment 70 connects the second transverse reinforcement 60.2 of the primary structure 60 and the second spar 58.2 of the wings 50. In this configuration the first and second front wing attachments 66, 66′ and the intermediate wing attachment 68 are positioned in substantially the same transverse plane, which limits the appearance of torque in the transverse and horizontal direction Y in the first spar 58.1.

Each front wing attachment 66, 66′ is configured to transmit forces in the longitudinal direction X. In a preferred configuration each front wing attachment 66, 66′ is configured to transmit forces only in the longitudinal direction X.

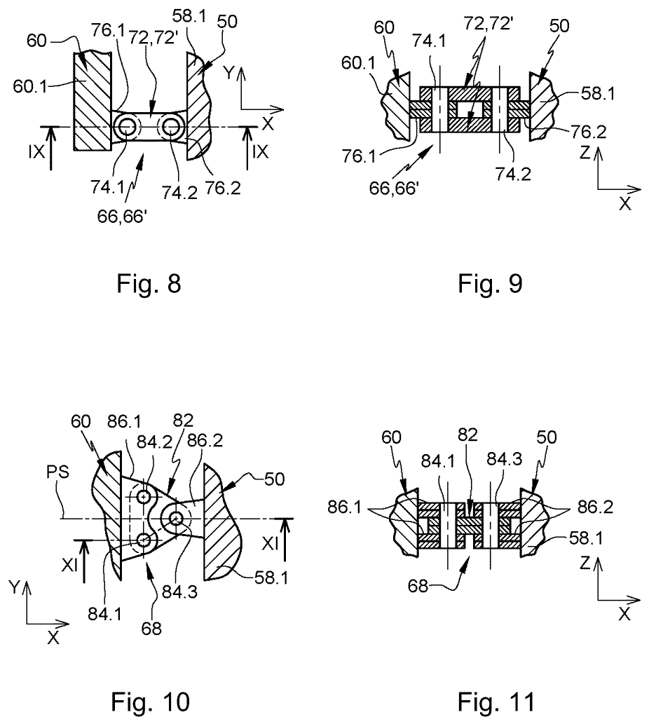

In a first embodiment that can be seen in FIGS. 5, 8 and 9 each of the first and second front wing attachments 66, 66′ includes at least one two-point link 72, a first connecting rod 74.1 connecting the two-point link 72 and the primary structure 60, more particularly the first transverse reinforcement 60.1, and a second connecting rod 74.2 connecting the two-point link 72 and the wings 50, more particularly the first spar 58.1 of the wings 50. The first and second connecting rods 74.1, 74.2 are parallel to one another and to the vertical direction Z, the second connecting rod 74.2 being offset toward the rear in the longitudinal direction X relative to first connecting rod 74.1.

In this first embodiment the primary structure 60 includes for each of the first and second front wing attachments 66, 66′ at least one first lug 76.1 rigidly attached to the first transverse reinforcement 60.1, which includes an orifice to accommodate the first connecting rod 74.1. In one configuration each first lug 76.1 includes two plates pressed one against the other. In parallel with this the wings 50 include for each of the first and second front wing attachments 66, 66′ at least one second lug 76.2 rigidly attached to the first spar 58.1 which includes an orifice to accommodate the second connecting rod 74.2. In one configuration each second lug 76.2 includes two plates pressed one against the other. In one arrangement each of the first and second front wing attachments 66, 66′ includes two two-point links 72, 72′ substantially parallel to one another and spaced from one another between which the first and second lugs 76.1, 76.2 are positioned.

In another embodiment that can be seen in FIGS. 12, 15 and 16 each of the first and second front wing attachments 66, 66′ includes a cylindrical tenon 78 rigidly attached to a first element of the combination comprising the primary structure 60 and the wings 50 that has an axis A78 substantially parallel to the vertical direction Z and an oblong housing 80 configured to accommodate the tenon 78 and rigidly attached to a second element other than the first element of the combination comprising the primary structure 60 and the wings 50 that has a first dimension in the longitudinal direction X equal to the diameter of the tenon 78 and a second dimension in the transverse and horizontal direction Y greater than the diameter of the tenon 78. The tenon 78 is therefore not able to move in translation in the longitudinal direction X relative to the oblong housing 80 but is able to move in translation in the oblong housing 80 in the transverse and horizontal direction Y.

In one configuration each tenon 78 is rigidly attached to the first transverse reinforcement 60.1 of the primary structure 60 and the oblong housing 80 is rigidly attached to the first spar 58.1 of the wings 50.

The first and second embodiments of the first and second front wing attachments 66, 66′ can be combined with the various embodiments of the intermediate and rear wing attachments 68, 70.

The intermediate wing attachment 68 is configured to transmit forces in the longitudinal direction X and in the transverse and horizontal direction Y. In a preferred configuration the intermediate wing attachment 68 is configured to transmit forces only in the longitudinal direction X and in the transverse and horizontal direction Y.

In a first embodiment that can be seen in FIGS. 5, 10 and 11 the intermediate wing attachment 68 includes at least one first three-point link 82, first and second connecting rods 84.1, 84.2 connecting the first three-point link 82 and a first element of the combination comprising the primary structure 60 and the wings 50, and a third connecting rod 84.3 connecting the first three-point link 82 and a different second element different from the first element of the combination comprising the primary structure 60 and the wings 50. The first, second and third connecting rods 84.1, 84.2, 84.3 are parallel to one another and to the vertical direction Z. In one configuration each three-point link 82 comprises two plates pressed one against the other.

In this first embodiment the primary structure 60 includes at least one first lug 86.1 rigidly attached to the first transverse reinforcement 60.1 which features at least one orifice to accommodate at least one of the first, second and third connecting rods 84.1, 84.2, 84.3. In one configuration each first lug 86.1 includes two plates pressed one against the other. In parallel with this the wings 50 include at least one second lug 86.2 rigidly attached to the first spar 58.1 which includes at least one orifice to accommodate at least one of the first, second and third connecting rods 84.1, 84.2, 84.3. In one configuration each second lug 86.2 comprises two plates pressed one against the other.

In one configuration the first and second connecting rods 84.1, 84.2 connect the first three-point link 82 and the first transverse reinforcement 60.1 of the primary structure 60. The third connecting rod 84.3 connects the first three-point link 82 and the first spar 58.1 of the wings 50. In this configuration the first lug 86.1 rigidly attached to the primary structure 60 includes two orifices to accommodate the first and second connecting rods 84.1, 84.2. The second lug 86.2 rigidly attached to the wings 50 includes an orifice to accommodate the third connecting rod 84.3.

In an arrangement that can be seen in FIG. 11 the intermediate wing attachment 68 includes a single three-point link 82 between a pair of first lugs 86.1 rigidly attached to the primary structure 60 and a pair of second lugs 86.2 rigidly attached to the wings 50.

In another embodiment that can be seen in FIGS. 12 and 14 the intermediate wing attachment 68 includes a yoke 88 rigidly attached to a first element of the combination comprising the primary structure 60 and the wings 50, a lug 90 cooperating with the yoke 88 rigidly attached to a second element different from the first element of the combination comprising the primary structure 60 and the wings 50, and a connecting rod 92 parallel to the vertical direction Z connecting the yoke 88 and the lug 90. Each branch of the yoke 88 comprises two plates pressed one against the other. The lug 90 can also comprise two plates pressed one against the other.

In one arrangement the yoke 88 is rigidly attached to the first transverse reinforcement 60.1 of the primary structure 60 and the lug 90 is rigidly attached to the first spar 58.1 of the wings 50.

The first and second embodiments of the intermediate wing attachment 68 can be combined with the various embodiments of the front and rear wing attachments 66, 66′, 70.

The rear wing attachment 70 is configured to transmit forces in the vertical direction Z and in the transverse and horizontal direction Y. In a preferred configuration the rear wing attachment 70 is configured to transmit forces only in the vertical direction Z and in the transverse and horizontal direction Y.

In a first embodiment that can be seen in FIGS. 5, 6 and 7 the rear wing attachment 70 includes at least one second three-point link 94, first and second connecting rods 96.1, 96.2 connecting the second three-point link 94 and a first element of the combination comprising the primary structure 60 and the wings 50, and a third connecting rod 96.3 connecting the second three-point link 94 and a second element different from the first element of the combination comprising the primary structure 60 and the wings 50. The first, second and third connecting rods 84.1, 84.2, 84.3 are parallel to one another and to the longitudinal direction X.

In this first embodiment the primary structure 60 includes at least one first lug 98.1 rigidly attached to the second transverse reinforcement 60.2 which features at least one orifice to accommodate at least one of the first, second and third connecting rods 96.1, 96.2, 96.3. In one configuration each first lug 98.1 comprises two plates pressed one against the other. In parallel with this the wings 50 include at least one second lug 98.2 rigidly attached to the second spar 58.2 which features at least one orifice to accommodate at least one of the first, second and third connecting rods 96.1, 96.2, 96.3. In one configuration each second lug 98.2 comprises two plates pressed one against the other.

In one configuration the first and second connecting rods 96.1, 96.2 are rigidly attached to the second transverse reinforcement 60.2 of the primary structure 60 and the third connecting rod 96.3 is rigidly attached to the second spar 58.2 of the wings 50. The primary structure 60 includes two first lugs 98.1, 98.1′ featuring orifices to accommodate the first and second connecting rods 96.1, 96.2, respectively. The second lug 98.2 rigidly attached to the wings 50 includes an orifice to accommodate the third connecting rod 96.3.

In an arrangement that can be seen in FIG. 7 the rear wing attachment 70 includes two three-point links 94 between which are positioned the first and second lugs 98.1, 98.1′, 98.2.

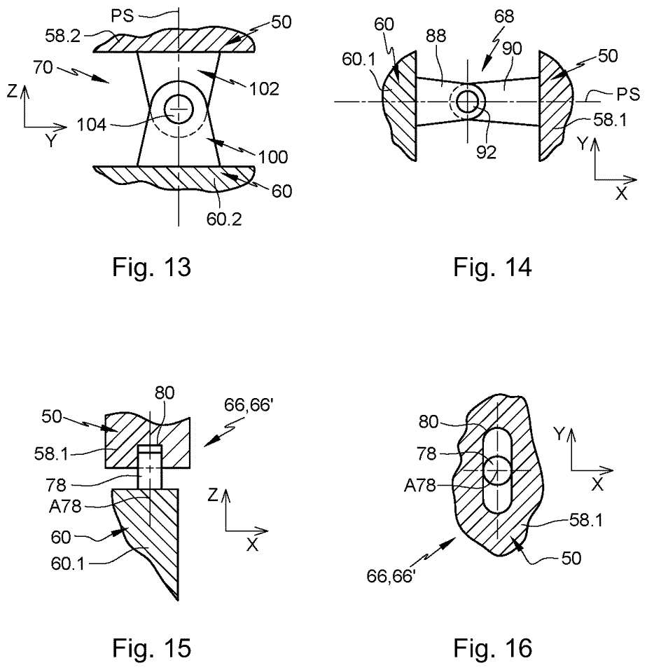

In another embodiment that can be seen in FIGS. 12 and 13 the rear wing attachment 70 includes a yoke 100 rigidly attached to a first element of the combination comprising the primary structure 60 and the wings 50, a lug 102 cooperating with the yoke 100 rigidly attached to a second element different from the first element of the combination comprising the primary structure 60 and the wings 50, and a connecting rod 104 parallel to the longitudinal direction X connecting the yoke 100 and the lug 102. Each branch of the yoke 100 comprises two plates pressed one against the other. The lug 102 can also comprise two plates pressed one against the other.

In one arrangement the yoke 100 is rigidly attached to the second transverse reinforcement 60.2 of the primary structure 60 and the lug 102 is rigidly attached to the second spar 58.2 of the wings 50.

The first and second embodiments of the rear wing attachment 70 can be combined with the various embodiments of the front and intermediate wing attachments 66, 66′, 68.

Regardless of the embodiment the forces oriented in the longitudinal direction X are transmitted by the first and second front wing attachments 66, 66′ and the intermediate wing attachment 68. Forces oriented in the transverse and horizontal direction Y are transmitted by the intermediate and rear wing attachments 68, 70. Forces oriented in the vertical direction Z are transmitted by the rear wing attachment 70. Torques oriented in the longitudinal direction X are essentially transmitted by the rear wing attachment 70. Torques oriented in the transverse and horizontal direction Y are essentially transmitted by the intermediate wing attachment 68. Torques oriented in the vertical direction Z are essentially transmitted by the first and second front wing attachments 66, 66′.

The invention makes it possible to reduce the number of parts of the wing attachment system (which contributes to reducing its weight) and to obtain a limited overall height at the level of the front and intermediate wing attachments 66, 66′ et 68.

In contrast to the prior art thrust forces are not transmitted only via the intermediate wing attachment 68 but divided between the first and second front wing attachments 66, 66′ and the intermediate wing attachment 68, which contributes to reducing the stresses applied to the intermediate wing attachment 68 and consequently its section in a horizontal plane. To this end each of the first and second front wing attachments 66, 66′ includes at least one pivot pin parallel to the vertical direction Z and is configured to allow movement in the transverse and horizontal direction Y of the primary structure 60 relative to the wings 50. This solution makes it possible to obtain an isostatic wing attachment system 64.

In the first embodiment that can be seen in FIG. 5 the first and second connecting rods 74.1, 74.2 form two pivot pins and allow movement of the primary structure 60 relative to the wings 50 that has a component in the transverse and horizontal direction Y. In the second embodiment the tenon 78 forms a pivot pin, the oblong housing 80 allowing the tenon 78 to move in translation in the transverse and horizontal direction Y.

To obtain a safety connection at least one wing attachment from the front wing attachments 66, 66′, the intermediate wing attachment 68 and the rear wing attachment 70 includes at least one connecting element consisting of a lug 76.1, 76.2, 86.1, 86.2, 90, 98.1, 98.1′, 98.2, 102, a yoke 88, 100, and a two-point link 72, 72′ or a three-point link 82, 94 which comprises at least two plates pressed one against the other.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. An aircraft comprising:
wings;
at least one engine assembly that has an engine assembly axis parallel to a longitudinal direction perpendicular to a transverse and horizontal direction and a vertical direction;
at least one primary pylon structure;
at least one engine assembly system connecting the at least one primary structure and the at least one engine assembly; and
at least one wing attachment system connecting the wings and the at least one primary pylon structure, the at least one wing attachment system including
first and second front wing attachments positioned on respective opposite sides of a median vertical plane containing the longitudinal direction and configured to transmit forces in the longitudinal direction,
an intermediate wing attachment configured to transmit forces in the longitudinal direction and in the transverse and horizontal direction, and
a rear wing attachment configured to transmit forces in the vertical direction and in the transverse and horizontal direction,
wherein the first and second front wing attachments are each configured to allow movement in the transverse and horizontal direction of the at least one primary pylon structure relative to the wings and each includes at least one pivot rod parallel to the vertical direction.

2. The aircraft as claimed in claim 1, wherein the first and second front wing attachments each further include
at least one two-point link,
a first connecting rod connecting the at least one two-point link and the at least one primary pylon structure, and
a second connecting rod connecting the at least one two-point link and the wings,
the first and second connecting rods parallel to one another and to the vertical direction, and the second connecting rod offset toward a rear in the longitudinal direction relative to the first connecting rod.

3. The aircraft as claimed in claim 2, wherein the at least one primary pylon structure includes, for each of the first and second front wing attachments, at least one first lug that includes an orifice to accommodate the first connecting rod,
wherein the wings include, for each of the first and second front wing attachments, at least one second lug that includes an orifice to accommodate the second connecting rod, and
wherein each of the first and second front wing attachments further includes two two-point links substantially parallel to one another and spaced from one another between which the at least one first and at least one second lugs are respectively positioned.

4. The aircraft as claimed in claim 1, wherein each of the first and second front wing attachments further includes
a cylindrical tenon rigidly attached to one of the at least one primary pylon structure and the wings, the cylindrical tenon having an axis substantially parallel to the vertical direction, and
an oblong housing configured to accommodate the tenon and rigidly attached to the other of the at least one primary pylon structure and the wings, the oblong housing having a first dimension in the longitudinal direction equal to a diameter of the tenon and a second dimension in the transverse and horizontal direction greater than the diameter of the tenon.

5. The aircraft as claimed in claim 4, wherein each tenon is rigidly attached to the at least one primary pylon structure and each oblong housing is rigidly attached to the wings.

6. The aircraft as claimed in claim 1, wherein the intermediate wing attachment includes
at least one first three-point link,
first and second connecting rods connecting at least one first three-point link and one of the at least one primary pylon structure and the wings, and
a third connecting rod connecting the at least one first three-point link and the other of the at least one primary pylon structure and the wings,
wherein the first, second, and third connecting rods are parallel to one another and to the vertical direction.

7. The aircraft as claimed in claim 6, wherein the first and second connecting rods connect the at least one first three-point link and the at least one primary pylon structure and the third connecting rod connects the at least one first three-point link and the wings.

8. The aircraft as claimed in claim 1, wherein the intermediate wing attachment includes
a yoke rigidly attached to one of the at least one primary pylon structure and the wings,
a lug cooperating with the yoke rigidly attached to the other of the at least one primary pylon structure and the wings, and
a connecting rod parallel to the vertical direction connecting the yoke and the lug.

9. The aircraft as claimed in claim 1, wherein the rear wing attachment includes
at least one second three-point link,
first and second connecting rods connecting the at least one second three-point link and one of the at least one primary pylon structure and the wings, and
a third connecting rod connecting the at least one second three-point link and the other of the at least one primary pylon structure and the wings,
the first, second and third connecting rods parallel to one another and to the longitudinal direction.

10. The aircraft as claimed in claim 9, wherein the first and second connecting rods connect the at least one second three-point link and the at least one primary pylon structure and the third connecting rod connects the at least one second three-point link and the wings.

11. The aircraft as claimed in claim 1, wherein the rear wing attachment includes
a yoke rigidly attached to one of the at least one primary pylon structure and the wings,
a lug cooperating with the yoke rigidly attached to the other of the at least one primary pylon structure and the wings, and
a connecting rod parallel to the longitudinal direction and connecting the yoke and the lug.

12. The aircraft as claimed in claim 1, wherein the wings include first and second spars, the second spar offset toward a rear in the longitudinal direction relative to the first spar,
wherein the at least one primary pylon structure includes first and second transverse reinforcements, the second transverse reinforcement offset toward the rear in the longitudinal direction relative to the first transverse reinforcement,
wherein the first and second front wing attachments and the intermediate wing attachment connect the first spar and the first transverse reinforcement,
wherein the rear wing attachment connects the second spar and the second transverse reinforcement.

13. The aircraft as claimed in claim 1, wherein the first and second front wing attachments and the intermediate wing attachment are positioned in substantially a same transverse plane.

14. The aircraft as claimed in claim 1, wherein at least one wing attachment from the first and second front wing attachments, the intermediate wing attachment, and the rear wing attachment each include at least one connecting element selected from a group consisting of: a lug, a yoke, a two-point link, and a three-point link that comprises at least two plates pressed one against the other.
